(19) United States
(12) Patent Application Publication
(10) Pub. No.: US 2004/0029087 A1
(43) Pub. Date: Feb. 12, 2004

(54) System and method for training and managing gaming personnel

(76) Inventor: Rodney White, Elgin, IL (US)

Correspondence Address: Dean D. Niro, Niro, Scavone, Haller & Niro, Suite 4600, 181 West Madison Street, Chicago, IL, 60602, US

(21) Appl. No.: 10/214,999

(22) Filed: Aug. 8, 2002

(51) Int. Cl. G09B 19/00

(52) U.S. Cl. 434/219

(57) ABSTRACT

In commercial and recreational gaming environments, the inventions provide systems and methods for training and managing gaming industry personnel on basic and advanced gaming strategy and monitoring techniques for a variety of wagering games. Automated training stations incorporate hardware and sequential software elements to facilitate and encourage the initial training and continuing education of gaming industry personnel at a variety of experience levels. Administrative features of the software provide means to customize the training experience and monitor progress for each unique system user.

### FIELD OF THE INVENTION

The inventions described herein relate to commercial and recreational gaming environments and the personnel who manage and operate businesses in these environments. More specifically, the inventions relate to methods and systems for training gaming industry employees and others who interact with the public in these settings.

### BACKGROUND OF THE RELATED ART

Any business that derives revenue from offering gaming services to its customers such as blackjack, roulette, baccarat, poker, craps, slot machines, and the like, depends on a compliment of trained personnel to monitor the gaming activities of its customers to confirm that the customers are playing in accordance with the rules of the establishment. In addition, each such business has an interest in sustaining a brisk pace of play for its wagering games to improve the total daily “handle” of the business. Often, the pace of play can be enhanced by gaming personnel who can recognize, collect and pay the wagers of its patrons without delay.

These businesses have an interest in seeing that their personnel are well trained, both in the standard method of play for each of the games offered, and also in recognizing the strategies unscrupulous customers occasionally employ to circumvent the rules of the house. If unchecked or unnoticed, these rogue players can have a significant negative impact on the expected return on the gaming services being offered. Also, the expected return on gaming services is beneficially increased where well trained personnel handle wagering transactions swiftly and accurately. Therefore, it is critically important to any business in this industry to have well trained employees.

In the past, businesses commonly looked to their own frequent customers for potential employees, since these were individuals know by their presence and their play to be familiar with the services offered by the establishment. More recently, many vocational schools have been founded for the express purpose of independently recruiting and training their students for positions in the gaming industry. These students complete a specified course of study and are awarded a certificate or other record of completion that represents to prospective employers that the student has received a particular amount of training and education. Other training methods known in the art include the use of flash card systems, text books, software, distance learning and videotape series.

The prior art training systems have several shortcomings for those who must rely on skilled gaming personnel. First, businesses that offer gaming services have a need for their personnel to receive ongoing training to refresh their skills and to educate them on disfavored practices that are new or that are occurring more frequently. Secondly, there is a need to independently confirm that the personnel are actually completing their assigned training and to measure the proficiency of each trainee. Third, there is a need to provide incentives to gaming staff to encourage ongoing development. There is also a need for management personnel to have a resource that monitors the performance of every trainee and to customize the training systems to suit the unique needs of each individual business and each individual employee. Accordingly, the inventions described below respond to these needs with unique systems and methods for training gaming industry personnel.

### SUMMARY OF THE INVENTION

The inventions described below present systems that are based in an electronic environment that includes logic processors and circuitry such as are found in desktop computers, laptop computers, palmtop computers, hand held devices, kiosks, network terminals, interactive video systems and similar products. The electronic system executes software routines which can be locally or remotely stored. The software routines commonly consist of five logical program blocks including: 1) a user identification block; 2) a communication block; 3) a training block; 4) a scoring block; and 5) an administrative block. The blocks may be combined or subdivided in any given program or set of programs without substantially changing the claimed systems. Further, each block is commonly comprised of multiple subroutines that have an association with the general function of the block. For example, the function of the training block is to present tutorials and examinations to a user/trainee for a variety of games of chance. The specific game or games of chance present in any particular system will depend on the unique needs of the system operator and the trainees who will be using the system.

The function of the user identification block is to condition access to the training system, and to record a history of interaction with the system that is unique to each user. This block may also provide higher level access to the system for various administrative tasks which may include security settings, content editing, data storage and retrieval, and other supervisory tasks. The identification block may also be used as a timekeeping system that records things such as the amount of time spent using the system or as an electronic time clock that records the check in and check out time for each employee.

The function of the communication block is to enable both one way and two way interaction between system users and management. Examples of one way interaction include the posting of notices relating to upcoming events, daily assignment schedules, information required by law or regulation, personal disciplinary notices, advertisements, branding, and any other presentation of information that does not require a response from the user. Examples of two way interaction include messaging systems (such as e-mail), opinion polling, skill testing, menu based query systems, employment application forms, job orientation presentations, and any other display that requires the collection, storage or transmission of a user response. The interaction between users and management via the communication block may occur locally at the user interface or remotely through the various fixed and wireless networking systems as are known in the art. Interactions may occur in real time (as in the example of a user selecting from menu items for additional information) or on a delayed basis (as in the example of e-mail). The form of the user display is not essential to the system. The display of content resulting from the use of the communication block (or any other block) may be text only, text and graphics, frames, video, audio, any combination of display formats or other forms as are known in the art.

The function of the training block is to educate the user on both the standard play and alternative strategies for various games of chance, and to encourage ongoing development and retention of gaming skills. Unique programs can be devised and executed for any game offered by the system administrator including blackjack, roulette, baccarat, poker, craps, slot machines, and the like. Training programs can take many forms including standardized tests, simulated game play, simulated dealer play, tutorial play, competitive play, and entertainment play. When timing and scoring are included in the training, the trainee is encouraged to hone the skills of the game at greater speeds and greater proficiency. The form of the user interface for the training block is not essential to the system. The user interface may be comprised of input by keyboard, mouse, trackball, pen, stylus, touchscreen, voice command, remote control, IR device, any combination of the above, or any other input methods as are known in the art.

The function of the scoring block is to monitor and record data relating to the results of any scored exercise initiated in any of the other program blocks. Scoring may include a variety of measured values including time, accuracy, quantity, historical trends, currency, comparative performance, threshold performance, incentive based credits, statistical functions and other variables as are known in the art. Data handled in the scoring block can be locally or remotely stored, transmitted or retrieved by the variety of manual, electronic and wireless techniques as are known in the art.

The function of the administrative block is to send, receive, edit and store the input and output of the other program blocks. Typically, access to the administrative block is restricted (preferably through the user identification block) by key, password, magnetic swipe, biometric sensor or other secure authorization means. The administrative block may include subroutines for creating, editing and deleting user data; human resources applications, viewing and manipulating scoring data; creating and editing content for the communication and training blocks; basic electronic file management functions and other system management and maintenance tasks as are known in the art.

Although many alternative structural forms are contemplated for the system, a preferable form houses the electronic elements in a kiosk type enclosure. The kiosk is generally mobile allowing the system to be placed in a location that is appropriate for training. A mobile system provides flexibility to the gaming operator, permitting the deployment of multiple units in places where gaming staff normally congregate during breaks so as to encourage casual and repeated use of the training system. Alternatively, dedicated training space can be defined, permitting the use of one or more kiosks in an environment that is relatively free of distractions.

Definition of Terms

The following terms are used in the claims of the patent and are intended to have their broadest meaning consistent with the requirements of law:

computer—a programmable device that can store, retrieve and process data. Multiple computers can be used in place of “a computer” even when a single computer is referenced;

module—a grouping of programs or program elements;

program or software—any machine operable code that can be stored on a computer permitting it to operate or perform a function;

shoe—a device used to distribute playing cards

source code—a command or series of commands in a programming language that directs a computer to perform a specific task;

subroutine—a portion of a module;

Where alternative meanings are possible, the broadest meaning is intended. All other words in the claims are intended to be used in the normal, customary usage of grammar and the English language.

### BRIEF DESCRIPTION OF THE DRAWINGS

FIG. 1 is a flow diagram for a user identification block.

FIG. 2 is a flow diagram for a communication block.

FIG. 3 is a flow diagram for a polling block.

FIG. 4 is a flow diagram of an orientation/reorientation block.

FIG. 5 is an operational overview of one embodiment of a training and management system.

FIG. 6 is a flow diagram for the initial test in one embodiment of a training and management system.

FIG. 7 is a flow diagram of the educational card counting game in one embodiment of a training and management system.

FIG. 8 is one example of a high scores listing display.

FIGS. 9 and 9a are a flow diagram of the basic strategy chart exercise and a display of the basic strategy chart, as filled out.

FIG. 10 is a flow diagram for the edit users module of the administration portion in one embodiment of a training and management system.

FIGS. 11 to 18a are representative screen displays of a portion of the displayed content for each of the functional program blocks.

FIG. 19 is a detailed flow chart of the preferred version of the blackjack training game.

FIG. 20 is a sample display of a high score screen.

FIGS. 21 to 22 are exemplary flow diagrams presenting alternative configurations for high level programming blocks that embody the invention.

FIG. 23 is an exemplary embodiment of a housing for the interactive training system.

### DETAILED DESCRIPTION OF PREFERRED EMBODIMENTS

Set forth below is a description of what is currently believed to be the preferred embodiments or best examples of the claimed inventions. Future and present alternatives and modifications to the preferred embodiments are contemplated. Any alternatives or modifications which make insubstantial changes in function, in purpose, in structure or in result are intended to be covered by the claims of this patent.

It is recognized that every software programmer adopts his or her own style in authoring software directed to the accomplishment of a defined task, choosing programming languages and tools that best fit the programmer's style in light of the task presented. The inventions described herein do not depend on the application of any particular programming language or programming style. As an aid to understanding one programmer's approach to creating software that accomplishes the objectives of an embodiment of the invention, a non-limiting example of source code written in the Visual Basic programming language is attached in microfiche form as an appendix.

One objective of a preferred embodiment of the invention is to provide the system operator with a means for identifying individual current or prospective employees as unique users of the training system. The system operator is provided with an input interface, in this example in the form of edit screens, that present data fields for the entry of unique identification data. Any data form capable of identifying a unique user is consistent with the objectives of the invention. In this example, the identification data includes user name and social security number. In addition, the system operator may desire to assign a security clearance level to each user. Categorizing users by an authorization class allows the system operator to group users by one or more common characteristics such as job type, seniority, performance history, and the like, thereby permitting the system operator to customize content based on group or individual characteristics. Once a unique user profile is created by the system operator, the user may then access the training system.

It is recognized that many authorization procedures are suitable for the purposes of the invention including key, password, magnetic swipe, biometric sensor and other authorization means as are known in the art. In a preferred embodiment of the invention, users are issued an access card containing a magnetic strip that stores information about the user. Swiping the card through a card reading device identifies the user to the system and, upon confirmation, grants user access accordingly.

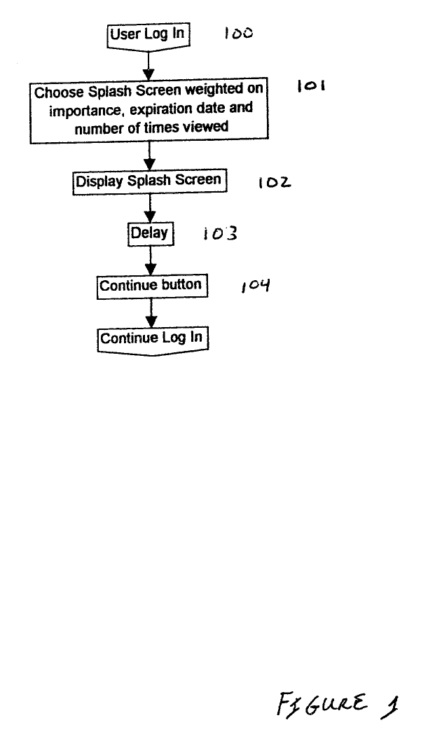

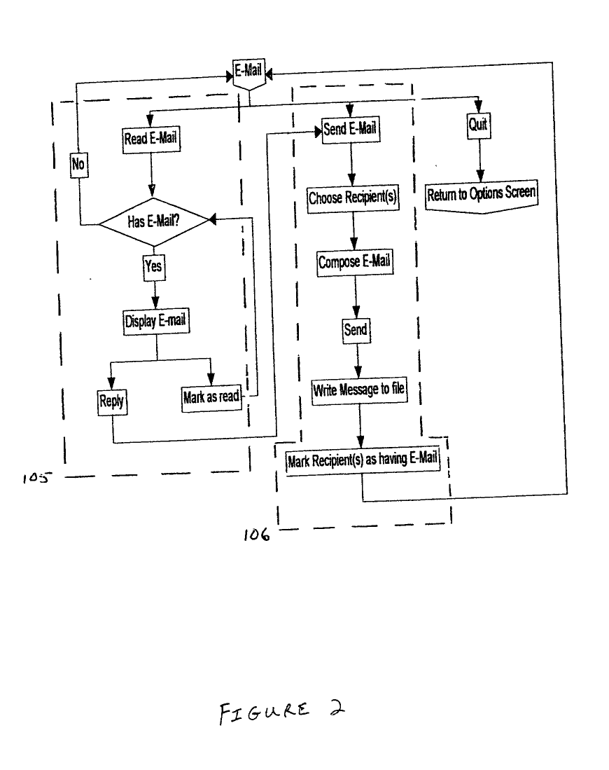

FIG. 1 shows a flowchart of the selected log-in screen procedures in the preferred embodiment. When a user logs in, the user is first authorized (as described above). Once the user is authorized, and completes the log-in operation 100, an appropriate splash screen may be shown during splash screen operations 101 and 102. The splash screen will be selected based on importance, expiration date, and times viewed or any other criteria deemed preferable by the administrator or programmer. After an appropriate delay 103, a continue button will be made active (at operation box 104) on the touchscreen and the user may proceed to continue logging in and use the training and management system.

Once user access is authorized, the system may present one of several optional program modules to the user including: communication modules, training modules, and scoring modules. The determination of the specific module may be controlled by the system operator or alternatively may be controlled by the user through the use of menu options, active icons or other selection means as are known in the art. In a preferred embodiment, the user is presented with a personalized welcome screen containing active areas on a touch screen that may be optionally selected.

The Communication Module

In the event that the user selects a communication module, the system will activate one or more program subroutines related to the transfer or collection of information between the system operator and the user as in FIG. 1. In a preferred embodiment, the communication module may display “splash screens” to the user. The system operator can set the importance of each splash screen and its expiration date. The splash screens may be used to communicate upcoming company events such as a boxing match, Christmas party details, meetings or any other information the company wants to share with its personnel.

The communication module may also be used to provide a system for authoring, sending or receiving messages, such as an e-mail system, discussion board, or other messaging systems as are known in the art. Messages sent or received may be broadcast to a group of users or specifically directed to an individual user or to the system operator. In a preferred embodiment, these messages are locally stored and forwarded. However, it is within the understanding of the invention that an alternative embodiment of the system may employ a connection to a remote server or to other kiosk type stations. In this configuration, the messaging functions may involve store and forward message system elements that are remotely located from the user's kiosk.

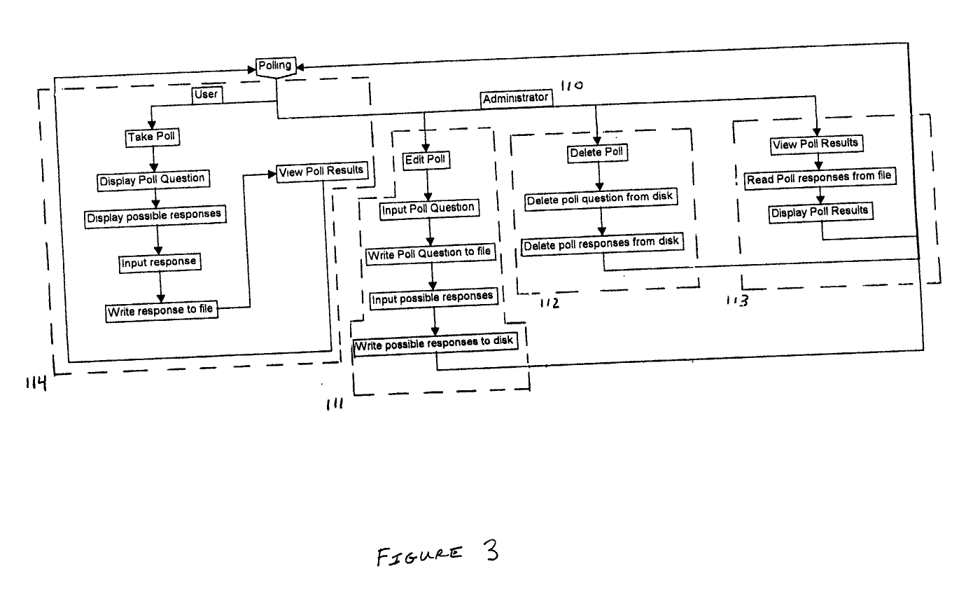

FIG. 2 shows one possible implementation of an e-mail subsystem, which permits the user to read and send e-mail. The key features of the e-mail implementation shown are the e-mail reading operations 105 and the e-mail sending operations 106. Any number of variations on a simple e-mail system will be known to one of ordinary skill in computer programming. A more complicated e-mail system could be provided as an alternative, or no e-mail subsystems at all.

Another function of the communication module offers the system operator the ability to poll individual users on matters of interest to the business. The polling module provides an opportunity for the business to solicit input from its personnel on a wide variety of issues including working conditions, employee benefits, business suggestions, and other topics of interest. Polling forms and responses may be stored and retrieved locally or remotely in various embodiments of the invention.

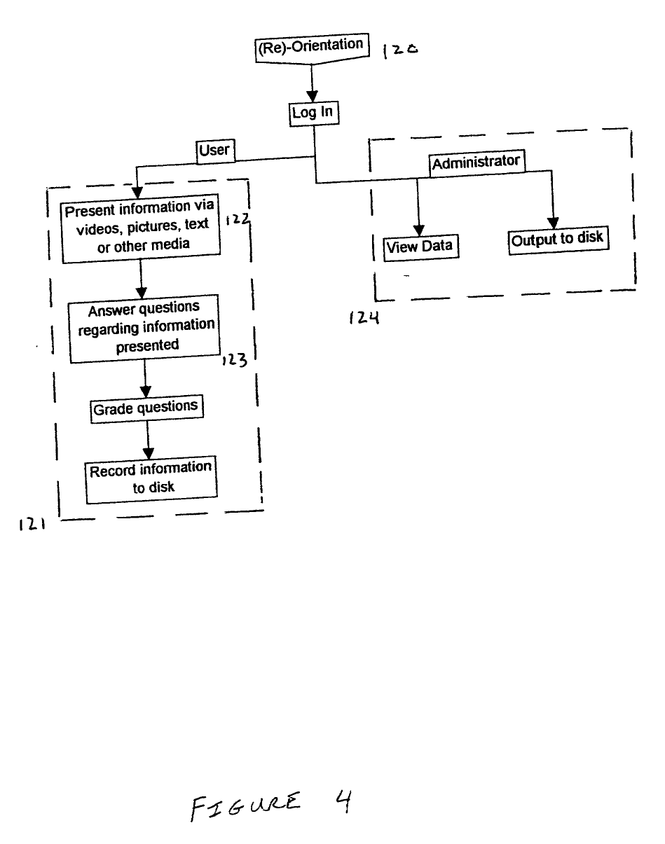

FIG. 3 shows a flowchart for an implementation of a polling subsystem. Such a subsystem could be added as a part of the login procedure, or at any other convenient location in the overall training and management system. In the preferred version of the polling subsystem, two separate levels of access are provided. In administrator operations 110, an administrator may edit a poll in editing operations 111 by inputting questions and answers, delete a poll in deletion operations 112 or view poll results in viewing operations 113 from an existing poll. In user operations 114, a user participates in the poll by entering a series of responses which are written to a file for later review by an administrator, and the user may view his own responses (though not typically those of other users). The administrator may permit the viewing of a summary of responses by users as well as the user's own results if it is deemed desirable for users to view the results.

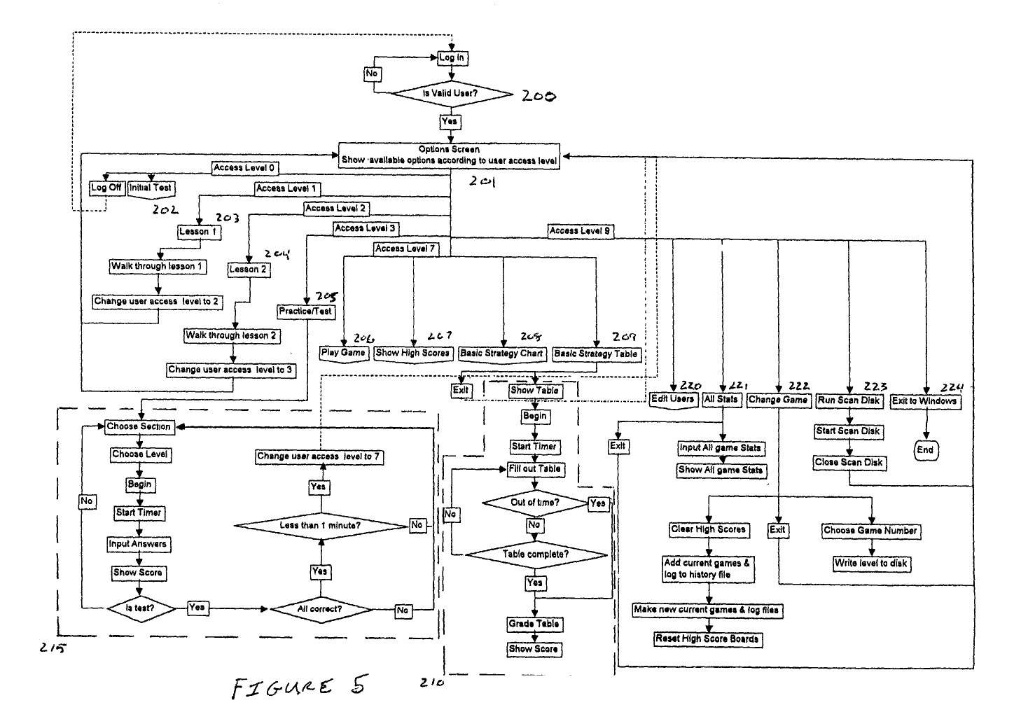

Also within the communication module, a user may receive an orientation session on a particular aspect of the business, or general policies and practices. In a common business practice, new employees or those in need of a periodic refresher course are given a book to read or videotape to watch describing company policies and practices. FIG. 4 shows a preferred embodiment of the invention where the employee may receive this orientation or reorientation 120. The system can record data that confirms the designated personnel logged into the system, through log-in operations 100, activated the orientation/re-orientation operations 121 module and viewed the designated audio visual materials 122. In addition, the system can implement testing operations 123 to query the user before, during or after the orientation 121 to gauge comprehension of the information presented.

Queries within the communication module may also take the form of an examination of the user on any topic of interest to the business. The system operator can employ tutorial operations 124 to create an examination in any form known in the art including multiple choice, true/false, essay, fill in the blank and others. The examination can be stored within the system and presented to the user at a designated time or upon request.

The Training Module

In the event that the user selects a training module, the system will offer one or more program subroutines related to educating the user on the methods of operation, play or strategy of a wagering game. Wagering games include among other things the conventional casino games of blackjack, roulette, craps, baccarat, poker (standard draw and many variations as are known in the art), slots, pai gow games, let it ride, Spanish 21, Red Dog, Catch-a-Wave, Monopoly®, and others as are known in the art. The form of the training is not critical to the invention. Training may be presented in an instructional setting with question and answer exercises; may include simulated play of a wagering game; may place the user in the position of a player, game operator, game supervisor or other role; or may take any other training form as is known in the art. In a preferred embodiment, the training is interactive in nature requiring the cooperation and response of the user to progress from the beginning to the end of a training exercise. As an incentive to encourage the user to persist in use of the system and build proficiency, a preferred embodiment of the training module includes timing and scoring elements as are discussed in greater detail elsewhere in the specification.

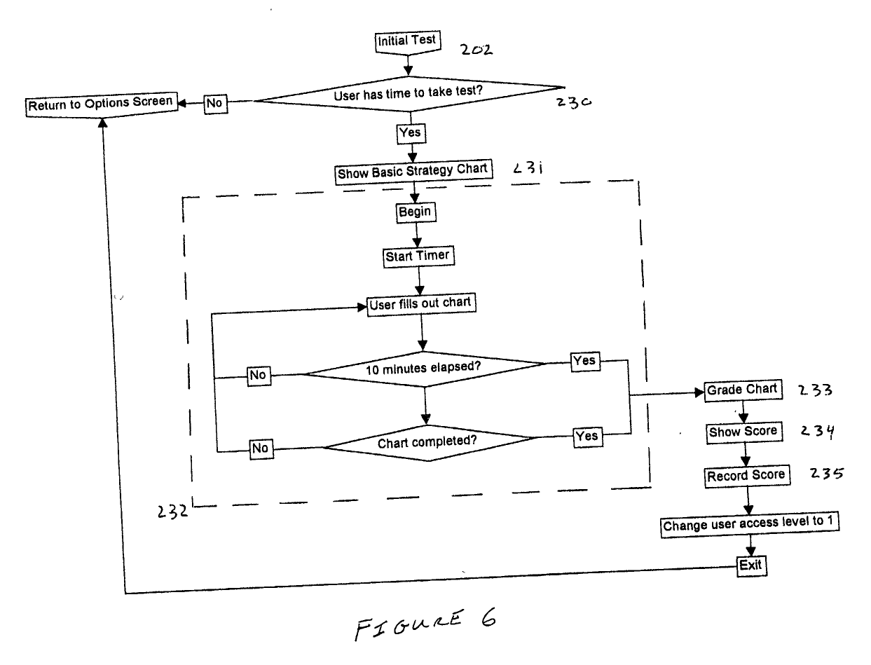

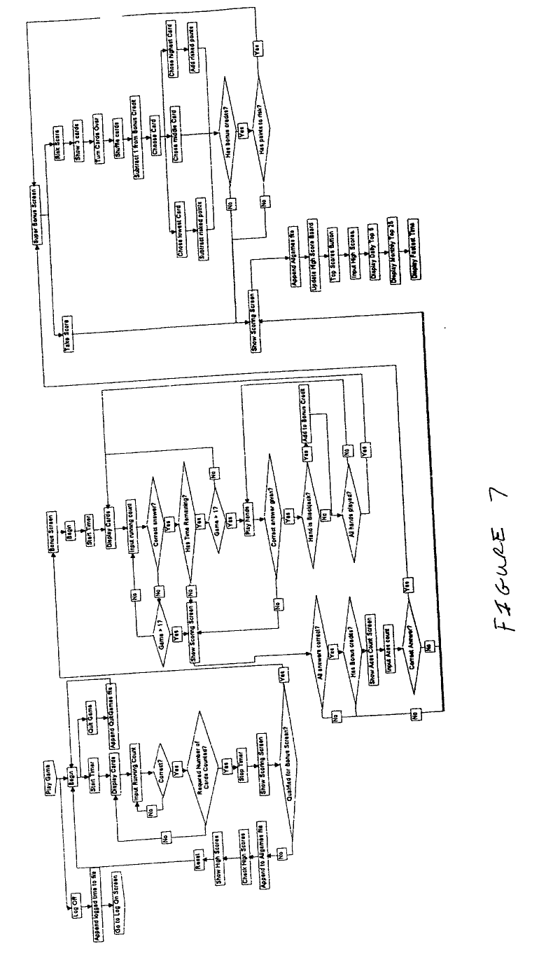

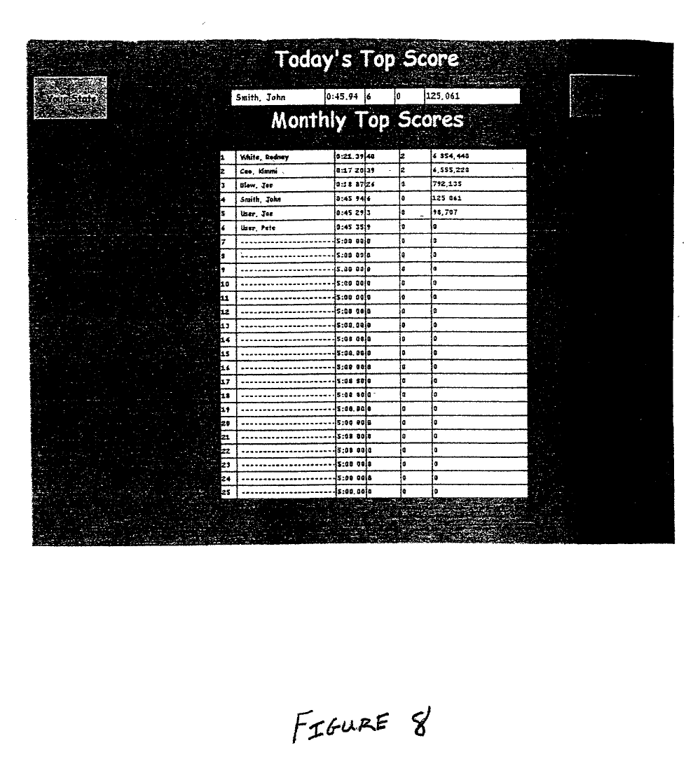

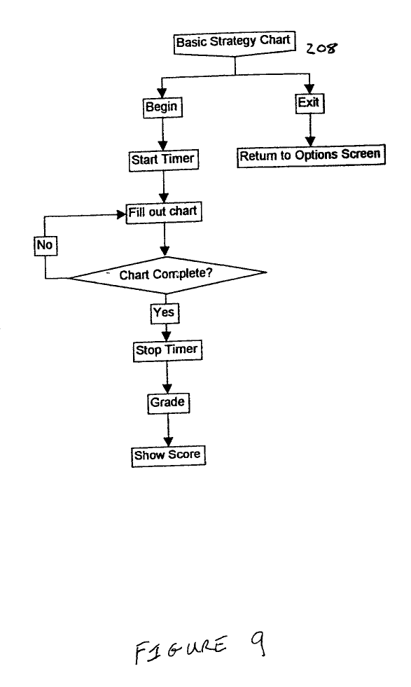

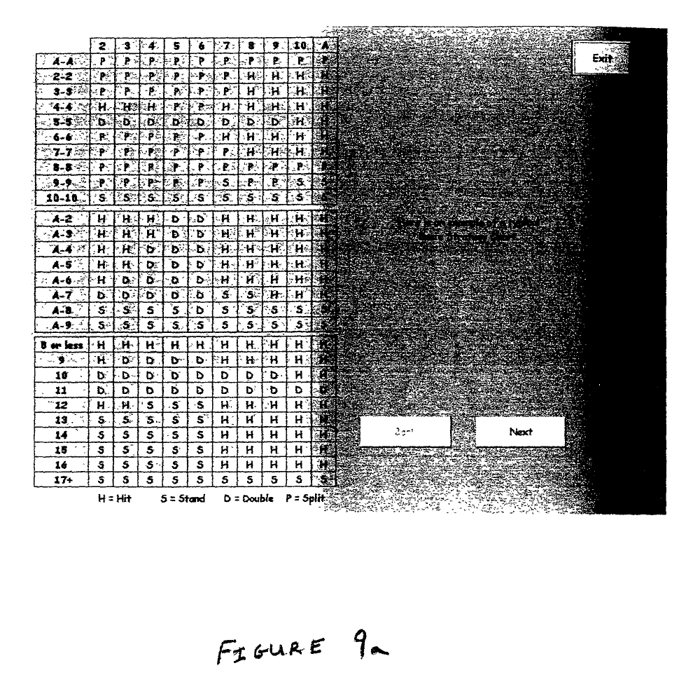

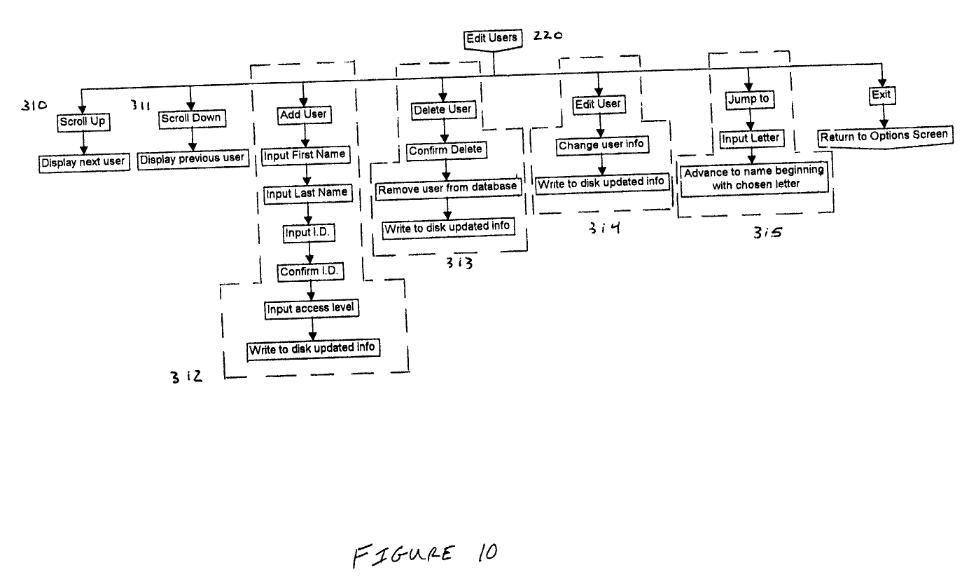

FIG. 5 shows an operational overview flowchart of the different options for play and education offered to a user and administrator for a blackjack training system. The default presentation is a log in screen. When a user logs in at decision diamond 200, the user (if valid) is presented with the options available to the user at the options screen operation 201. If the user has access level 0 they will only be presented the option to play the initial test 202. (See FIG. 6) After completing the initial test the user's access level will be increased to access level 1. Typically the user has access level 0 when the user has never used the system before. If the user has access level 1, then the user will be presented with the first lesson 203. Upon completion of the Lesson 1 203, the user's access level will be increased to level 2, as shown in Lesson 1 operations 203. If the user has access level 2 then the user will be presented with the second lesson, and upon completion the user's access level will be increased to level 3, as shown in Lesson 2 operations 204. Once the user has attained level 3, the user will be given the ability to access the basic strategy practice/test as shown in Level 3 operations 205 and begin storing results. As shown in training game operations 215, the user can elect to practice the test (by choosing level as ‘practice’ or ‘test’, which will result in a ‘yes’ result at the “Is test?” diamond in training game operations 215), or take the test for qualification for additional access. Once the user can complete the test perfectly in under a minute, the user will be given access to level 7 and returned to the operations screen, with permission to fully utilize the education and training system. It is anticipated that a typical user will practice several times before successfully completing the test. Note that each access level has access to the operations allowed to all lower access levels. For example, a user with access level 7 can access the lessons, the practice test, and all operations available to users of levels 1, 2 and 3 as well as those only available to a user of level 7 or higher. A user of level 7 will be permitted to participate in the basic strategy practice/test, view high scores, view the basic strategy chart, and play a basic strategy game. Once the user has access level 7, the user, in addition to the lessons and practice test, may access the full version of the educational and card counting game 206 (See FIG. 7), the high scores listings 207 (See FIG. 8), and the Basic Strategy Chart 208 (See FIGS. 9 & 9a) and Table 209.

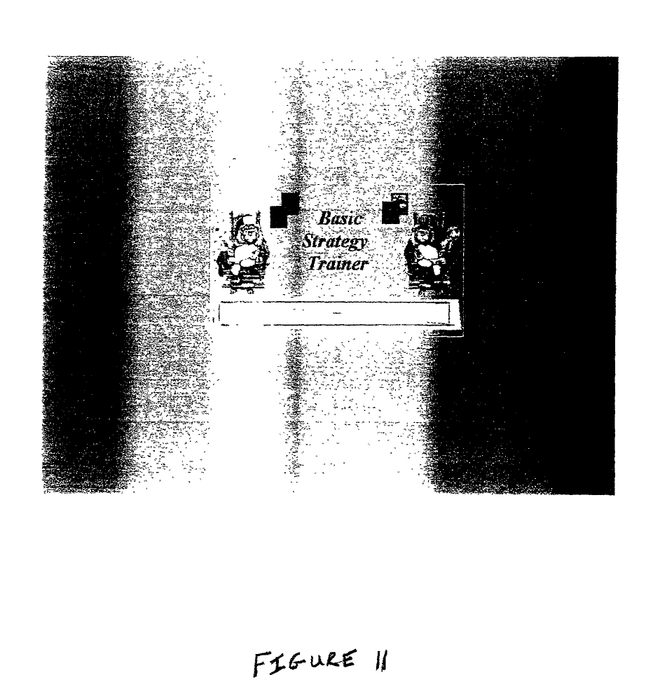

An administrator will have additional access. The administrator can participate as an ordinary user, but will also have access to the user file in edit users 220 (See FIG. 10), view and input game statistics in All stats operations 221, change the game in change game operations 222, and run a scan disk operation 223 or exit to windows to perform maintenance on the system. In All stats operations 221 the administrator may either input and change stored game stats by hand, or view the game stats. This permits the administrator to view the progress of the participants.

A basic strategy subroutine in a preferred embodiment teaches gaming personnel the optimal method for playing a particular wagering game. In the example of blackjack, a basic strategy subroutine teaches the user the best way to play blackjack without knowing or attempting to know the composition of the remaining cards in the dealer's “shoe.” It begins by having the user fill out a basic blackjack strategy chart in less than 10 minutes. It then teaches the user the patterns to look for, promoting memorization of responses to particular patterns. The user practices the basic strategy training module until the user can successfully pass a test in less than 1 minute. Upon successful completion of test the user is then allowed to play the “Game”.

FIG. 6 shows a flowchart for the initial test operations 202 in the blackjack example. The initial test 202 is the basic strategy chart 231 for blackjack, which the user must complete in order to access the additional lessons and features of the system. The user is asked if they have the time to take the test at decision diamond 230. If so, the basic strategy chart is displayed at operation 231 and the user is given the opportunity to fill the chart out with the correct responses. Once the user has completed the chart, or if ten minutes has elapsed and the user has not completed the chart, the system will grade the chart at grade chart operation 233, show the score to the user at show score operation 234, and record the score at record score operation 235, then change access to level one. The user need not be correct at this stage, though the score will depend on the number of correct answers. Upon changing access, the user will be returned to the options screen.

The game consists of responding to situational card combinations correctly according to the basic strategy, then using any remaining time to play simulated hands of blackjack. In a preferred embodiment, the “Game” is set up to be a 4 month training program, with slight variations each month to retain user interest, reinforce certain principles of play, or increase speed and accuracy. There may also be extra “bonus” screens to enhance competitiveness and fun. The duration of the training sessions is discretionary with the system user. Training routines of less than a day or more than a year also fall within the scope of the invention.

Continuing the blackjack example, a second training subroutine introduces instruction on card counting, a conventionally disfavored practice at gaming establishments. The card counting program teaches a user how to count cards in order to have knowledge as to the composition of the cards remaining in the “shoe.” The subroutine may teach any user defined counting system. In this example, the subroutine teaches a basic “hi-lo” count as is known in the art. The user begins by learning the value assigned to each card and how to count down a single deck two cards at a time. The user will then progress to counting multiple decks and being shown multiple cards at a time. As the user progresses, the card combinations will be presented and the user will keep track of the running count as well as play the hands out using basic strategy and keep side counts.

The principle objective is to be able to glance at a table and be able to “count” the cards as fast as possible so that, as the dealer or supervisor, the user can run down a “shoe,” determine if any of the players are counting cards, and still be able to watch the other games in the user's assigned section.

In a preferred embodiment, the counting “Game” will consist of showing a Blackjack table and cards being dealt. The system will display a series of hands for blackjack and the system will ask the user to identify the “running count.” Initially the system will display two cards, ask for the running count, then an additional two cards and a request for an identification of the “running count”, followed by a series of tables of cards for up to seven players and a dealer, asking for the running count to be identified after each table. This program will also teach how to keep side counts. In a preferred embodiment, the “Game” is set up to be a 4 month training program, with slight variations each month to retain user interest, reinforce certain principles of play, or increase speed and accuracy. The duration of the training sessions is discretionary with the system user. Training routines of less than a day or more than a year also fall within the scope of the invention.

A third subroutine of the blackjack example offers the user training in recognizing and using the “Critical Index.” The “Critical index” or “indexing” program will teach the user when to vary from basic strategy when the “count” is at certain levels and what those levels are. The “Game” part of this program will consist of having the user keep track of the “running count”, convert the “running count” into the “true count” and playing a blackjack hand correctly according to the index. In a preferred embodiment, the “Game” is set up to be a 4 month training program, with slight variations each month to retain user interest, reinforce certain principles of play, or increase speed and accuracy. There may also be extra “bonus” screens to enhance competitiveness and fun. The duration of the training sessions is discretionary with the system user. Training routines of less than a day or more than a year also fall within the scope of the invention.

It is understood that similar training programs for other wagering games are within the scope of the invention. For illustration, some training subroutines based on other non-limiting wagering games are described in summary fashion as follows:

Roulette—The roulette program's objective is to increase speed and accuracy in determining roulette payouts. It will teach conventional shortcuts used in determining payouts as well as some mathematical shortcuts to help determine payouts quickly and accurately. The “Game” will present a roulette layout and randomly placed cheques on a selection of numbers. A timer will be used to encourage improvements in speed and recognition. As the rounds progress so will the amount of cheques that are placed thus increasing the difficulty. This “Game” will also have “bonus screens” to keep it fun and competitive.

Craps—The Craps program's objective is to increase the speed and accuracy in determining Craps payouts. It will teach conventional shortcuts used in determining payouts as well as some mathematical short cuts to help determine payouts quickly and accurately. The “Game” will show a Craps layout and randomly placed cheques on the layout. A timer will be used to encourage improvements in speed and recognition. As the rounds progress, so will the amount of cheques that are placed thus increasing the difficulty. This “Game” will also have “bonus screens” to keep it fun and competitive.

Baccarat—The Baccarat program will teach the user how to deal baccarat and the “third card rule” describing when the player and/or banker should receive a third card. It will also test the user on the 5% commission paid on winning banker hands.

Pai Gow Poker—The Pai Gow Poker program will teach the user how to correctly set the dealer's hand. It will show the dealer's seven cards and the user will have to indicate the appropriate two cards that should make up the dealer's “low” hand.

Slots—The slot program will teach slot personnel how to read a pay table and to correctly convert the winning payouts to their cash equivalent. It will show random pay tables with random winning combinations. It will also show the denomination of the machine and the number of coins/credits played. The user will have to then convert that information into the correct cash value payout.

The Scoring Module

In the event that the user selects a scoring module, the system will offer one or more program subroutines permitting the user to display or query data recorded by the system in response to the user's participation in other modules. In a preferred embodiment, the function of the subroutines of the scoring module is to monitor, record and display data relating to the results of any scored exercise initiated in any of the other program blocks. Scoring may include a variety of measured values including time, accuracy, quantity, historical trends, currency, comparative performance, threshold performance, incentive based credits, statistical functions and other variables as are known in the art. Typically a user's access to data in the scoring block is limited, based on the user's authorization level. Data handled in the scoring block can be locally or remotely stored, transmitted, retrieved or displayed by the variety of manual, electronic and wireless techniques that are known in the art.

FIG. 8 shows a flowchart for the high score display feature of the blackjack example. A user may view the high scores for the training games in which he has participated, and view the daily top 5 scores, the monthly top 25 scores, and the fastest time to complete the game. After viewing each high score, the user returns to the game or options screen, as appropriate.

The Administrative Module

In the event that the user selects an administrative module, the system will offer one or more program subroutines related to organizational records for the user that have been recorded or stored by the system. A different set of subroutines are available to the system operator, with access conditioned on a designated authorization level. In the event that a system operator selects an administrative module, the system will offer one or more program subroutines related to sending, receiving, editing and storing the input and output of the other program blocks. The administrative module may include subroutines for creating, editing and deleting user data; human resources applications, viewing and manipulating scoring data; creating and editing content for the communication and training blocks; basic electronic file management functions and other system management and maintenance tasks as are known in the art.

FIG. 10 shows a flowchart for the Edit Users operation 220. This is an option which is typically only available to the administrator. The administrator will have the option to view the users through use of the scroll up operation 310 and scroll down operation 311. The administrator may also add users, including their first name, last name, and identification number, along with an initial access level (typically 0), shown at add user operations 312. The entry of the identification number will preferably be performed twice, and compared, as shown in add user operations 312. The administrator may also delete users as shown in delete user operations 313; perform edit user operations 314, which permits the changing of any user information, or jump to a specific letter rather than using the scroll operations, as shown in jump to operations 315.

In a preferred embodiment, exemplary alternative administrative subroutines that are typically accessible by a user include:

Scheduling—Here the user is able to check his schedule, request time off, request vacation time, look for people to make schedule switches with, and other similar coordination tasks.

Disciplinary Actions—Most businesses that offer gaming services spend a great deal of time and energy keeping track of and administrating disciplinary actions to employees that are tardy or calling in sick. The user can access certain disciplinary records to be informed of actual or impending discipline, respond to alleged misconduct, report on the fulfillment of any disciplinary conditions, or otherwise be informed of specific or general disciplinary matters.

Time Keeping—A business that employs one of the claimed systems may choose to use the system to monitor the coming and going of its personnel via a time keeping subroutine. For the user, instead of “punching” a paper record on a conventional time clock, the employee “swipes” in to the system and is greeted with a visual/audio greeting. At this time, the system may confirm the user's arrival time and may also inform the user of his game/section assignment for the day. The timekeeping function may also be used to restrict authorized personnel from being present at an unauthorized time, either by denying premature entry or reporting delayed departure.

Employee Information Updating—The system may offer a subroutine allowing a user to update personal information such as phone number, address or other desired information by entering the revised information though the input interface.

Training Method Example—Blackjack

In a preferred embodiment of the invention, training a new user in the proper method of playing blackjack may involve the following sequence of events.

The system administrator logs onto the system and uses the editing tools of the administrative block to create a new user profile record (see FIG. 10). A user name and password (a social security number in this example) are created, and the user is assigned a skill level of 0 (signifying a new trainee with no prior experience). The user profile data is saved by the system and the system administrator issues a magnetic card containing a record of the user's identification to the new user. The system will now recognize the new user upon a swipe of the magnetic card and entry of the proper authentication code.

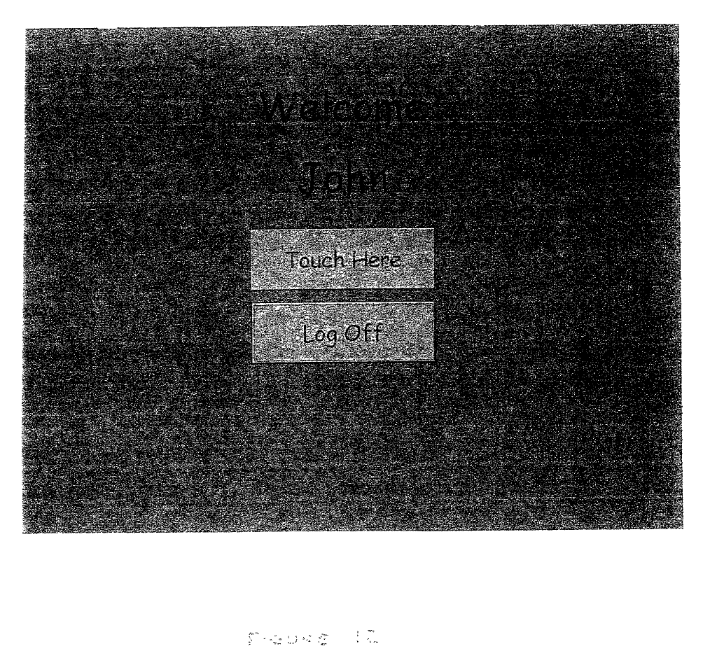

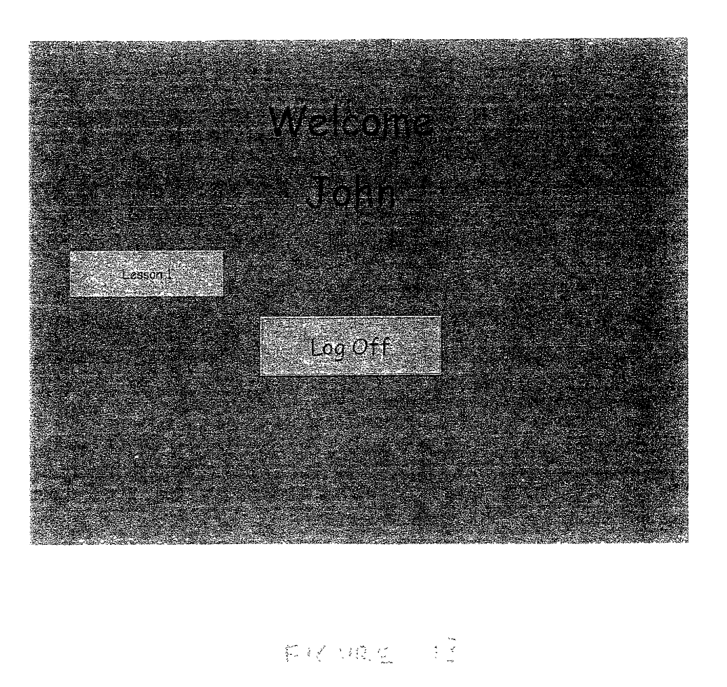

The user then approaches a kiosk 500 (or other form of training station) to initiate a training session. Since the kiosk 500 of this example has an active electronic display screen, it can display a general “brand” impression, legal notice, or other public information when not being used for training (see FIG. 11). The user swipes his magnetic card through a card reader at the kiosk. The system verifies the user name then presents a “welcome screen” to the user (see FIG. 12). Alternatively, the kiosk may use an optical card reader, a keypad for identification, or any other similar device for verification of the user's identity, including, for example, an entry screen with a touch keyboard for entry of name, social security number, or other identifying information. In this example, the content of the welcome screen is related to the proficiency level assigned to the user. At level 0, the user is presented with a limited menu of choices directing the user to either access the “base line” test that measures pre-training skills (“Touch Here”) or to log off the system.

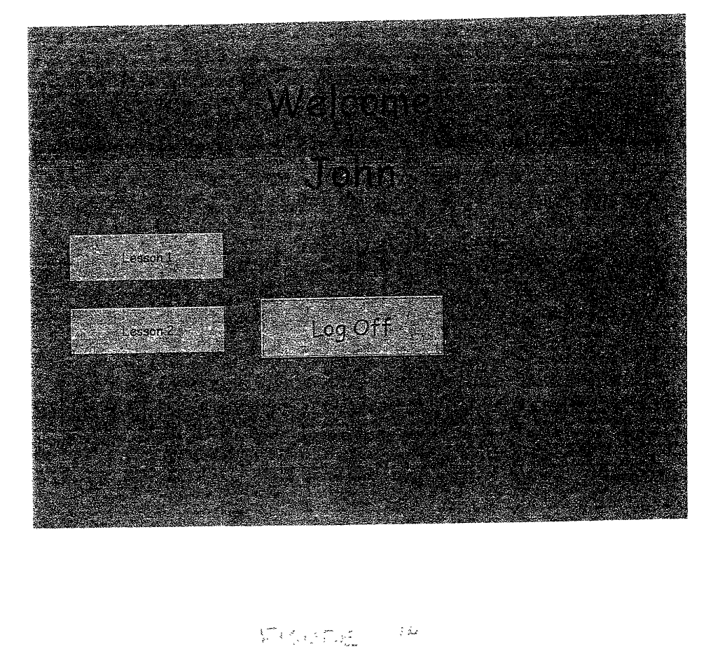

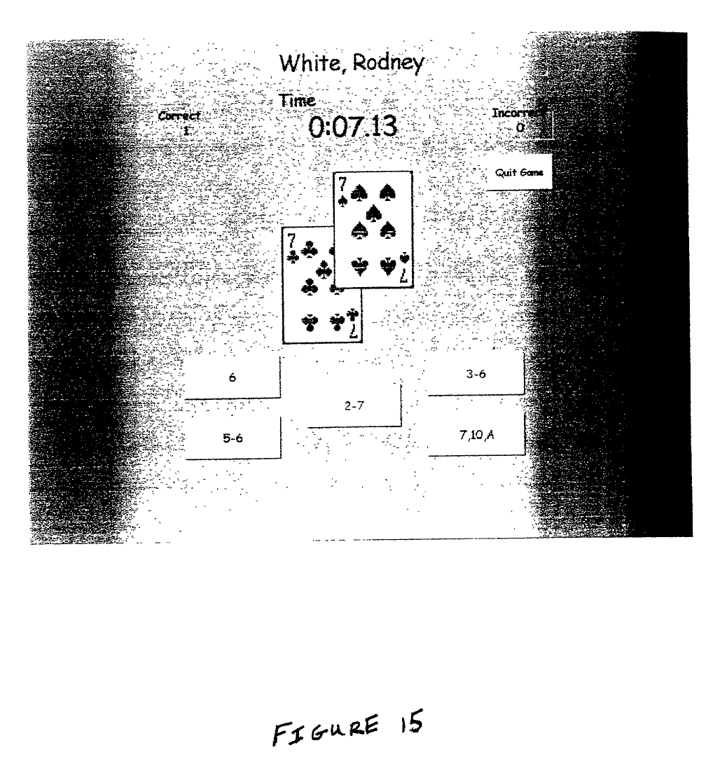

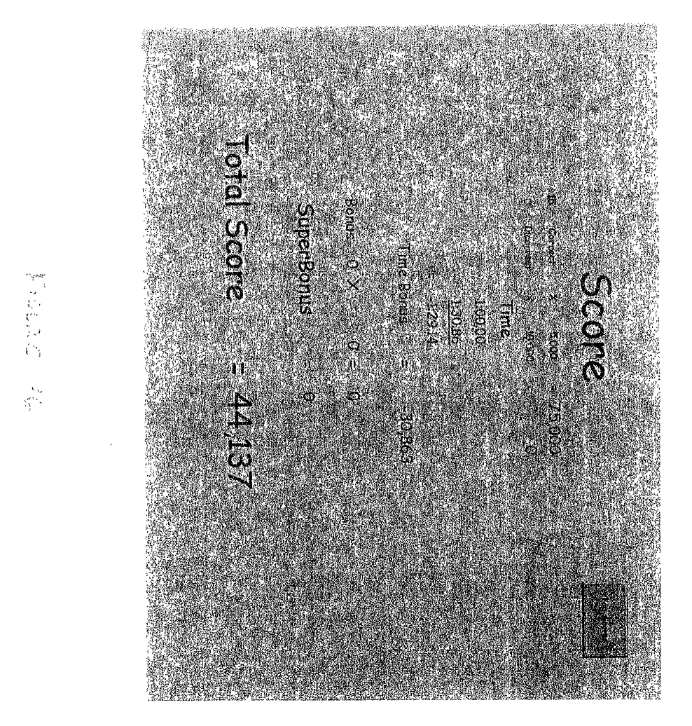

Once the user has completed the base line test, the system records the result and upgrades the user's profile data to skill level 1. When the user next returns to the welcome screen, an additional menu option for “Lesson 1” is presented (FIG. 13). In like fashion, completion of Lesson 1 results in another skill level upgrade and new menu choices at the welcome screen (FIG. 14). In this embodiment, the user proceeds through three interactive “lesson” and “practice” levels that teach the user how recognize various blackjack card combinations and the rules associated with a desired method of play (defined by the system administrator). In this example, the learning and practice levels measure correct user responses and the time taken by the user to complete the lesson, thus foreshadowing the elements of the game system that follows.

Upon completion of the initial learning levels, the system grants the user access to the blackjack game. In this example, the game displays a player's hand and offers multiple responses requiring the user to associate the displayed hand with a rule learned during the previous lessons and practice (FIG. 14). The game includes a timer and counters for correct and incorrect responses. The user must recognize the hand and enter the proper response in order to advance the game to another displayed hand. At any time, the user has the option of quitting the game by selecting the “Quit Game” option. Quitting returns the player to the appropriate welcome screen where the player may seek additional practice, start a new game, log off or perform any other activity offered at the welcome screen. Play continues until the user has entered a correct response for 15 displayed hands or has quit. At the conclusion of a game session, the system records the user's score and time and advances to a scoring screen.

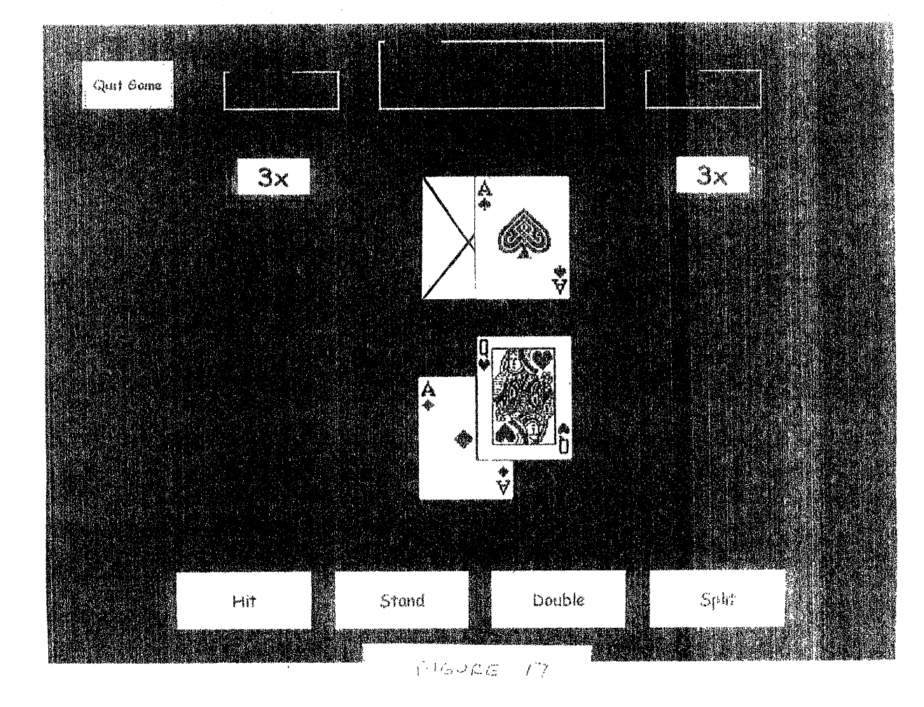

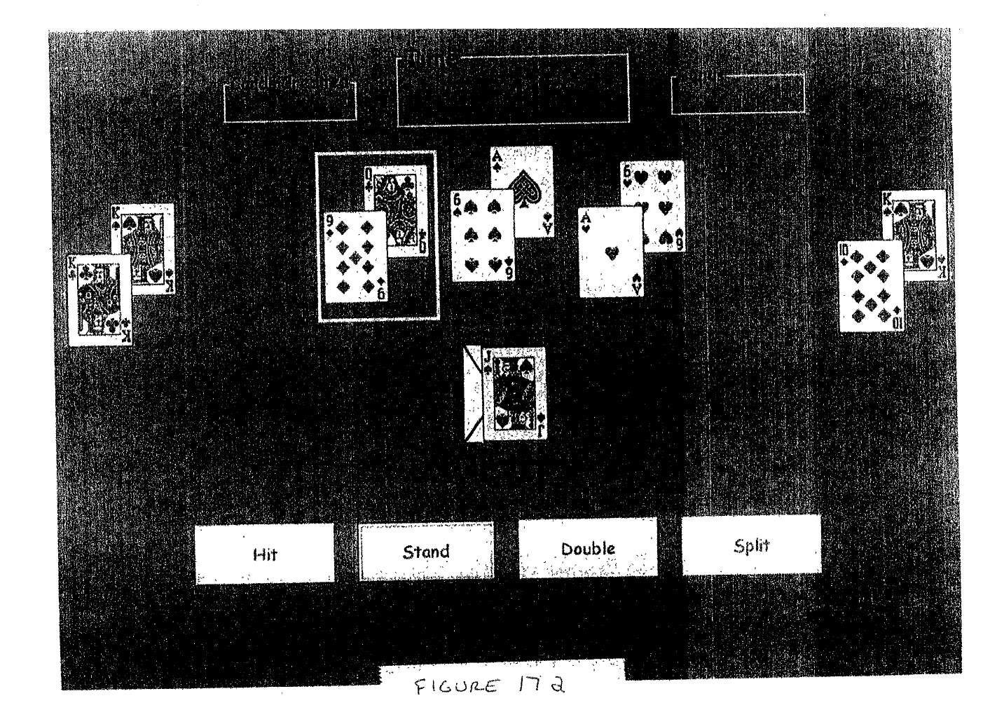

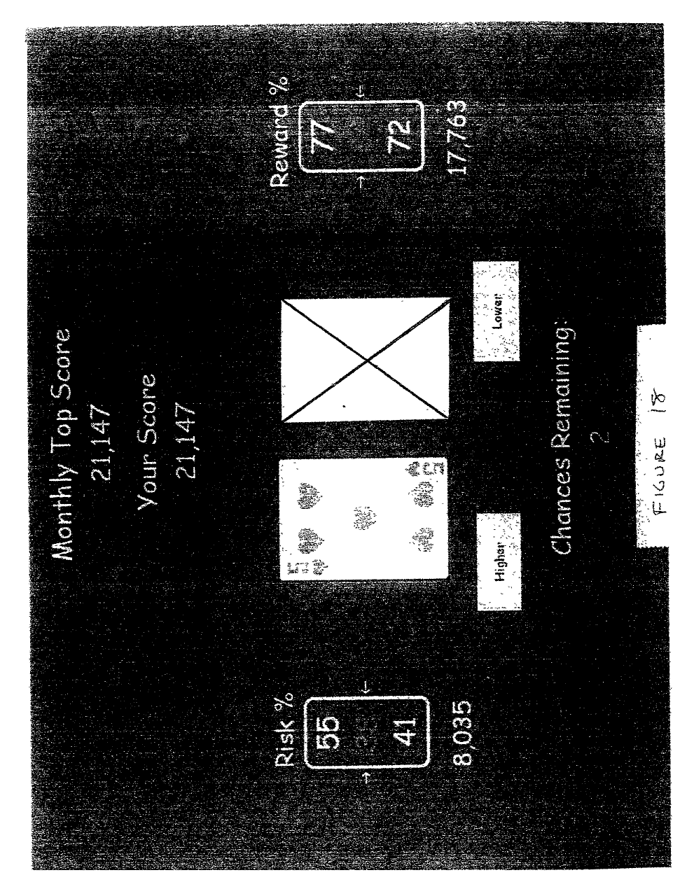

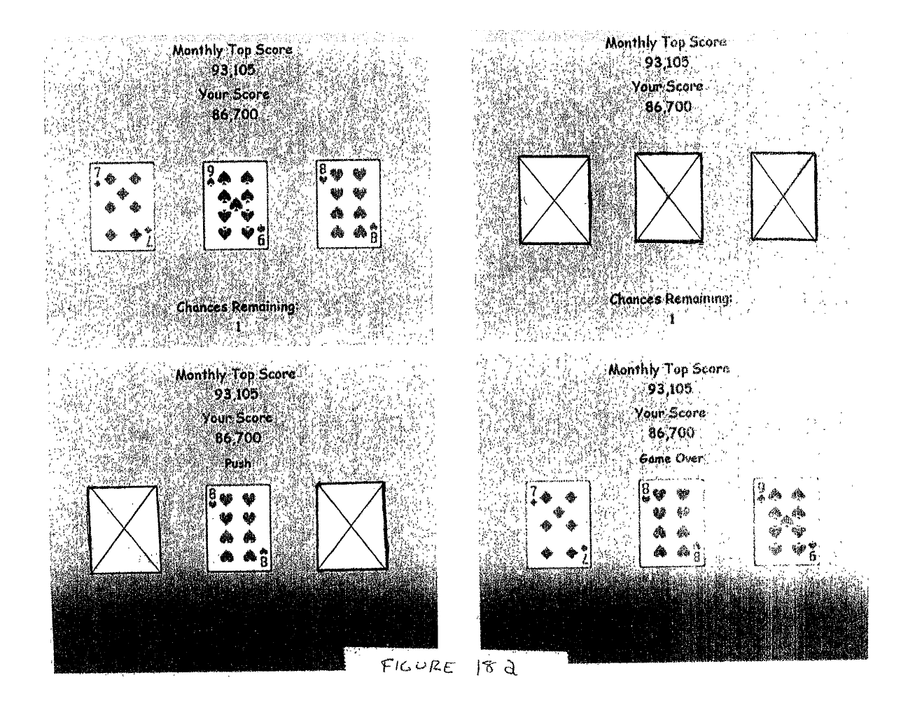

The scoring screen presents the user's game result and calculates a total score which, in this example, is based on a weighted combination of correct responses, incorrect responses, and time (FIG. 16). The system presents different menu options at the scoring screen based on the user's score. If the user's score falls below a set value, the user exits the scoring screen to a display screen that reports on the historical “high scores” for the game (described in greater detail below). If the user's score exceeds a preset minimum, the scoring screen presents a menu option for a “bonus round”. In this example, the bonus round presented to a qualifying user resembles an actual table game of blackjack with the user in the player's position with the customary range of player options (FIG. 17). The conclusion of the bonus round resembles the conclusion of the original game, taking the user to a scoring screen and calculating the new game score including bonus scoring. Again, if the bonus score is below a specified threshold the user exits the scoring screen to a display screen that reports on the historical “high scores” for the game. If the bonus score exceeds the threshold value, the user may participate in a “super bonus” session of the game (FIG. 18). If the super bonus round is invoked, the conclusion of the round returns the user to the “high scores” screen. Additional bonus (FIG. 17a) and super bonus (FIG. 18a) games are associated with the card counting game in the preferred embodiment, though a variety of methods are possible, including varying the bonus and super bonus games randomly. The purpose of the bonus rounds is to encourage play of the games and participation in the training system.

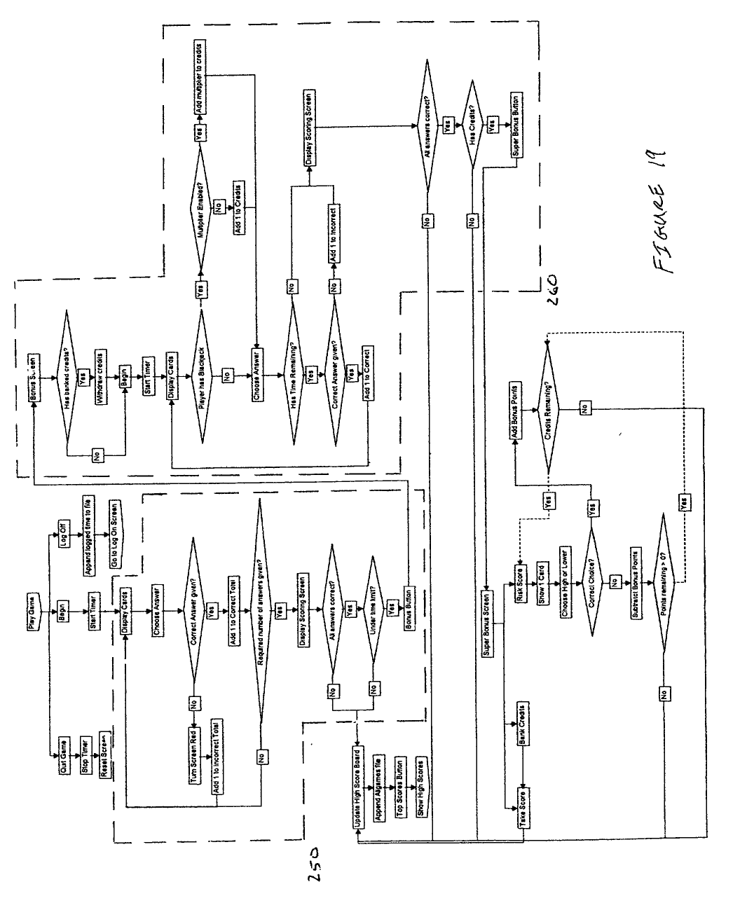

A detailed flow chart of the preferred version of the blackjack training game is shown at FIG. 19. As described above, the initial game is shown at game operations 250. This game requires the user to maintain a proper running count for the cards being dealt, and input a running count as a series of cards are dealt. The game continues to the bonus round operations 260 if the user qualifies. In the bonus round, the player is required to count cards and play hands as well, achieving a higher score based on the correct play of the hands and the time elapsed. After the user successfully completes the bonus screen, the user is automatically placed into the super-bonus screen, where the user may risk points from the score to increase the user's score, or conclude the game and take the score by selecting zero points to risk. After the play is concluded, the user's statistics, including their scores and time logged on the system, are sent to the file for the administrative module's tracking features.

In addition, in the blackjack training system, the user may participate in a basic strategy exercise similar to the initial test described above. The exercise is substantially similar to the initial test, with a three-minute countdown timer instead of a ten minute time limit.

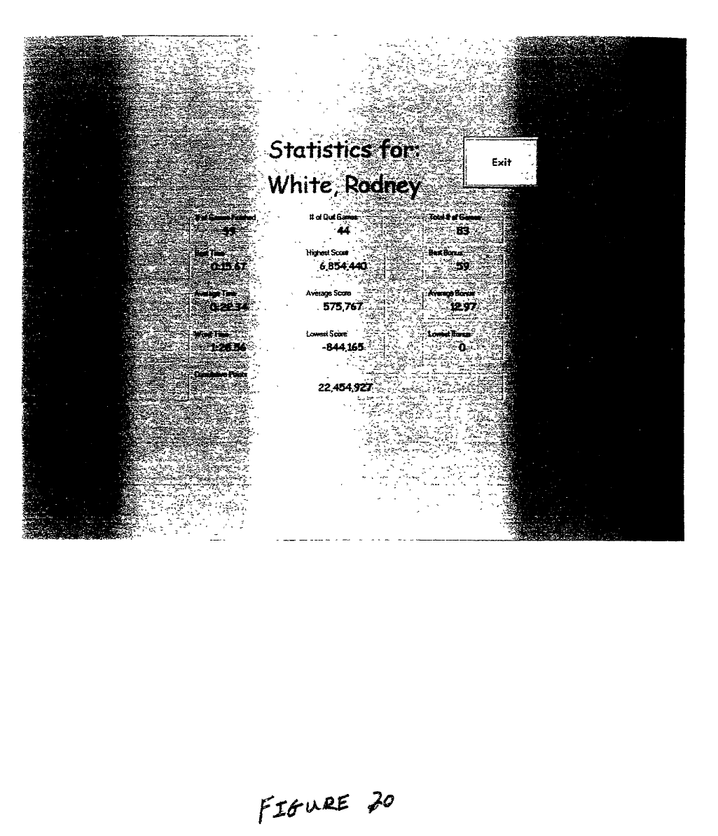

All games, both card counting and the basic strategy game, that are played to completion end at the “high scores” screen. In this example, the screen presents daily and monthly top scores for a defined group of users, allowing any individual user to compare his result with the results of other users similarly situated. The defined group is selected by the system administrator. In an alterative embodiment, the scoring data of one gaming establishment can be linked to the scoring data of other gaming establishments fostering competition among the staff of participating employers. The high score screen also presents a “your stats” menu option where a user can review his own historical scoring data (FIG. 20). The personal scoring data may include a summary of all games played by the user and statistical maximum, minimum and average values for time, raw score and bonus score records.

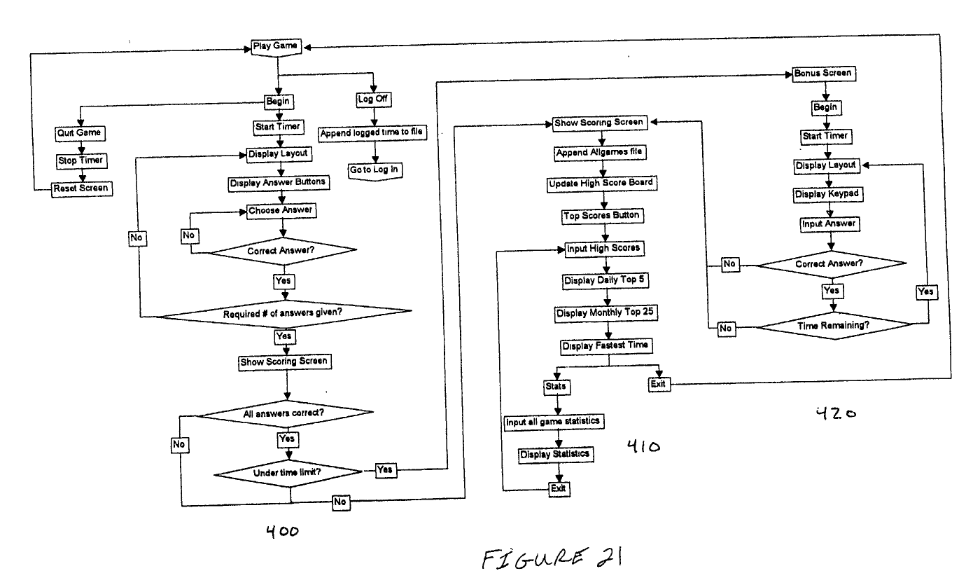

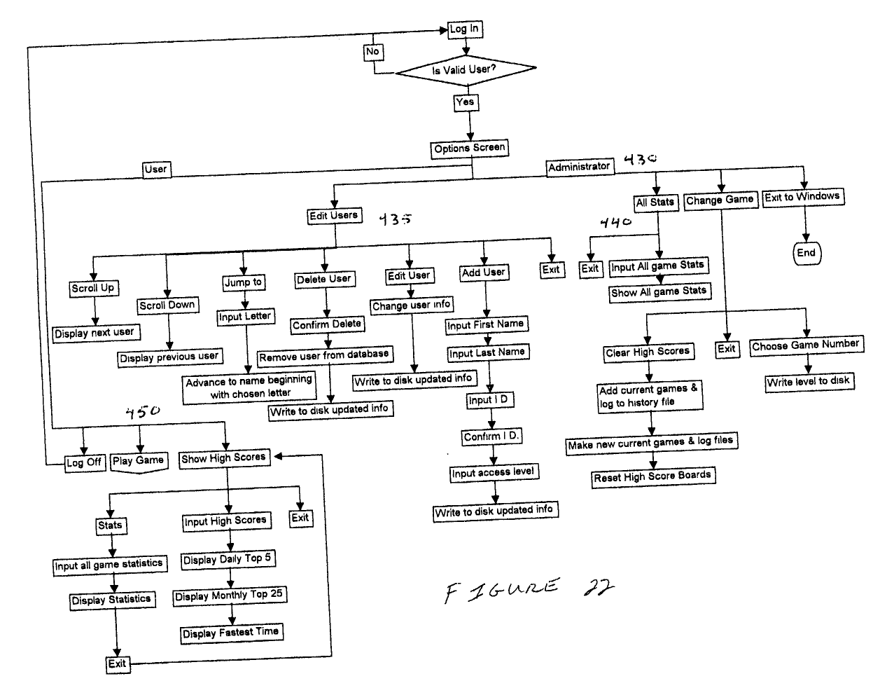

It is clear that the system and method described herein may also be adapted generally to other systems. FIG. 21 shows a general game flowchart for such an education game, including a set of game play operations 400, scoring and system display statistics operations 410, and bonus screen operations 420. FIG. 22 shows a system module flowchart for one embodiment of a generalized training system similar to the blackjack embodiment described herein, including administrative operations 430, with edit users operations 435 and statistics and game management operations 440. The features of these operations are similar to those employed in the blackjack example, and the advantages of the system and method are of equal use in training for other casino games. Similar training game operations 450 are present, again like the administrative operations, the features of the described blackjack system may be carried into other casino games, with all of the same advantages and benefits.

Structural Considerations

The system and method inventions described above are not dependent on any specific structural form. For illustrative purposes, this section describes one non-limiting structure that is considered compatible with a preferred embodiment of the invention.

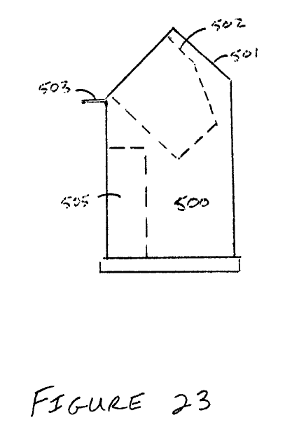

The point of user access to a system of the invention is preferably a kiosk type structure. FIG. 23 presents a kiosk 500 comprised of a housing 501 of suitable construction, a display device 502, an input interface 503, a power supply and the essential elements of a computer 505 including one or more microprocessors and suitable memory elements. If the system is deployed in a network environment, each kiosk would also include a communications link and may alternatively obtain the required computing resources from a remotely located source such as a client server.

The display device 502 may comprise a video screen, a monitor, a liquid crystal display (LCD), a cathode ray tube (CRT), a projection screen, or any other device suitable to provide a display function. The input interface 503 may comprise, either alone or in combination, a keyboard, touchpad, touchscreen, mouse, trackball, stylus, light pen, voice recognition device, puck, tablet or other device suitable to provide an input function. The power supply may comprise, either alone or in combination, an AC outlet connection, one or more batteries, an uninterruptible power supply (UPS) or other means suitable to provide power to the system. If included, the communications link can include any of several technologies, including a telephone link, satellite link, radio-frequency link, infrared link, internet link, facsimile link, fiber-optic link, coaxial cable link and television link.

The software elements of the invention are preferably stored and executed on the computer 505, either within the kiosk 500 or in remote communication with it. For efficient maintenance and operation, the kiosk 500 also includes an access interface for the system manager preferably including a file transfer device such as a CD drive, zip drive, diskette drive or similar device.

The above description is not intended to limit the meaning of the words used in the following claims that define the invention. Rather, it is contemplated that future modifications in structure, function or result will exist that are not substantial changes and that all such unsubstantial changes in what is claimed are intended to be covered by the claims.

What is claimed is:

1. A system for training gaming personnel comprising:
a computer;
an input system;
a display device; and
software that teaches the play of a wagering game.

2. A method for training gaming personnel comprising the steps of:
initializing a record representing a unique trainee;
running a software program that provides an interactive lesson relating to a wagering game;
requiring said trainee to respond to input prompts produced by said software;
recording a result based on the responses of said trainee.

3. A system for managing gaming personnel comprising:
a computer;
an input system;
a display device; and
software that permits management of training and communications with gaming personnel.

4. A method for managing gaming personnel comprising the steps of:
initializing a record representing a unique employee;
running a software program that provides access by an administrator to said record;
storing data regarding the employee
said data including at least information regarding participation in training by said unique employee.
